(19) United States
(12) Patent Application Publication
(10) Pub. No.: US 2008/0082385 A1
(43) Pub. Date: Apr. 3, 2008

(54) Project scheduling methods, systems, and apparatuses

(75) Inventors: Dennis G. Busch, Nelson, WI (US); Marie L. Marquardt, Alma, WI (US)

Correspondence Address: BROOKS, CAMERON & HUEBSCH , PLLC, 1221 NICOLLET AVENUE , SUITE 500, MINNEAPOLIS, MN, 55403, US

(73) Assignee: Buschmar Consulting, LLC

(21) Appl. No.: 11/522,558

(22) Filed: Sep. 18, 2006

(51) Int. Cl. G06F 9/46

(52) U.S. Cl. 705/8

(57) ABSTRACT

A project scheduling method including separating the project into a plurality of phases to be completed in a sequential order, determining a first start date for a first phase and determining a next start date for a next phase in the plurality of phases by adding a first maximum lead time to the first start date. Also, a start date can be determined for each of the plurality of phases by adding a maximum lead time for each phase to a previous phase start date until a completion date is obtained. In addition, it can be determined when an action is to be taken regarding an item from one of an equipment list and a materials list based on the start date for each of the plurality of phases.

### BACKGROUND

A large portion of the cost of construction is due to the expenses of cost estimation, the administration of the bidding process, contract and sub-contract management, generating documents needed for financing, and allowing for contingencies. In addition, cost changes are frequently experienced due to errors in cost estimation, mistakes in bidding, in dispute resolution with respect to contract obligations and performance responsibility, and change orders. For example, in some situations such contingencies and problems can add thirty (30) percent or more to the overall cost of the work, and resultant schedule delays can cause further consequential losses.

### BRIEF DESCRIPTION OF THE DRAWINGS

FIG. 1 provides an illustration of a Customer Shopping List according to an embodiment of the present disclosure.

FIG. 2 provides an illustration of an Electrical List according to an embodiment of the present disclosure.

FIG. 3 provides an illustration of a Customer Totals form according to an embodiment of the present disclosure.

FIG. 4 provides an illustration of an Equipment Ordering Worksheet according to an embodiment of the present disclosure.

FIG. 5 provides an illustration of a Material Ordering Worksheet according to an embodiment of the present disclosure.

FIG. 6 provides an illustration of a Labor Worksheet according to an embodiment of the present disclosure.

FIG. 7 provides an illustration of a Phase Totals Worksheet according to an embodiment of the present disclosure.

FIG. 8 provides an illustration of a Proposal Form according to an embodiment of the present disclosure.

FIG. 9 provides an illustration of a General Contractor Project Totals Sheet according to an embodiment of the present disclosure.

FIG. 10 provides an illustration of a Team Lead Time Scheduling Sheet according to an embodiment of the present disclosure.

FIG. 11 provides an illustration of an Extra Change Work Order form according to an embodiment of the present disclosure.

FIG. 12 provides an illustration of a calendar according to an embodiment of the present disclosure.

FIG. 13 is an illustration of a system embodiment of the present disclosure where the embodiments are provided on a computing system and are accessible using the Internet.

### DETAILED DESCRIPTION

Embodiments of the present disclosure are directed toward methods, systems, and apparatuses for bidding and/or scheduling a construction project. As used herein, a “project” can include the complete construction of a building starting with an open plot of land for a job site, a remodel of an existing structure, an add-on to an existing structure, or other jobs involving planning and bidding.

According to the present disclosure, there are several applications that may benefit from the methods, systems, and apparatuses as described herein. Such applications include a do-it-yourself customer who wishes to plan and schedule their own project, for example, a customer who wishes to build a garage onto his or her existing house. As used herein, “customer” refers to the person who will own the building after the construction is completed, or the person who owns the building and is requesting the add-on or remodel. Another application of the embodiments described herein can include a contractor bidding on a large project that may require several sub-contractors and extensive scheduling to finish the project on time and at the bidding price.

In addition, embodiments of the present disclosure may be provided on a computer readable medium where a contractor can complete various forms and the computer readable medium can include executable instructions to calculate a total project bid and/or to fill out a calendar with a list of tasks and/or start dates, among other things. Embodiments of the present disclosure can also be used as an educational tool, to teach how to schedule and/or provide a bid for a construction project, as well as to teach a systematic way to organize and/or prepare documents.

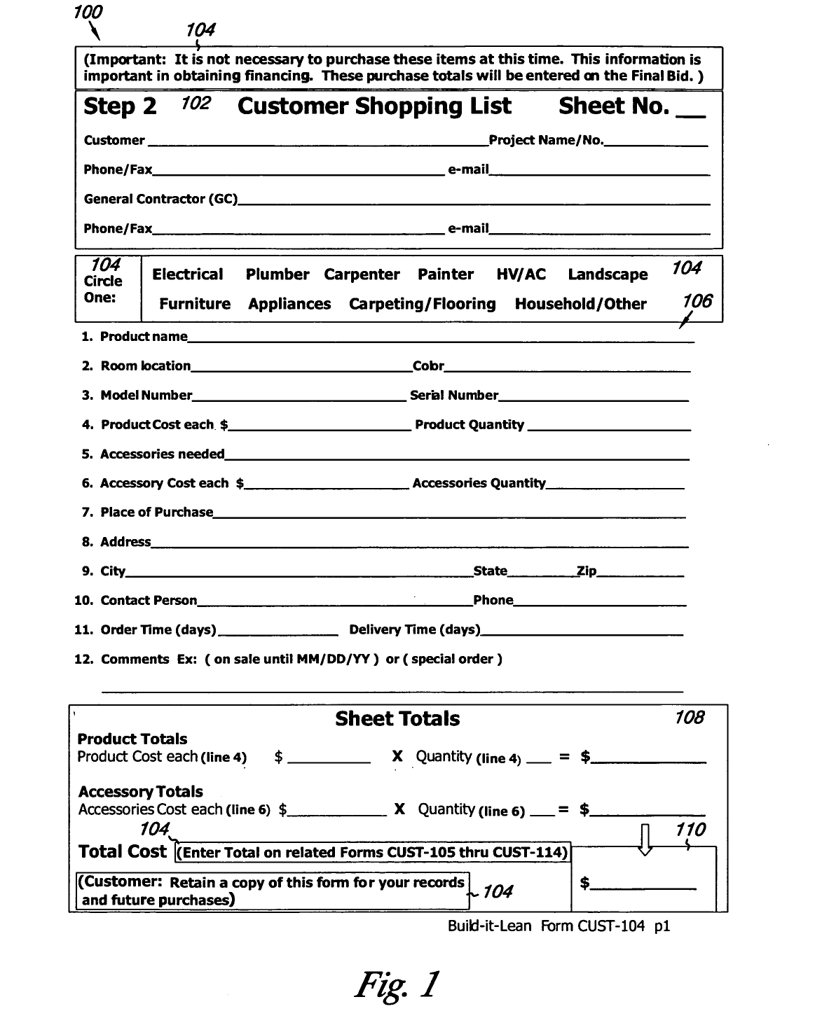

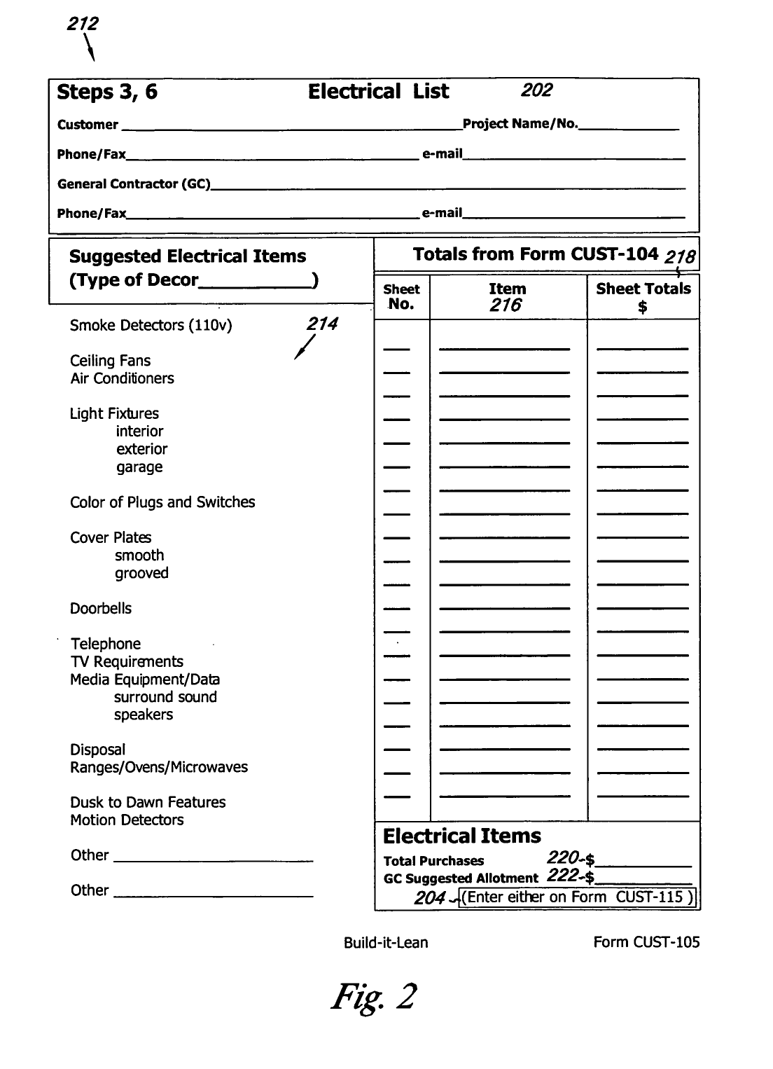

The figures herein follow a numbering convention in which the first digit or digits correspond to the drawing figure number and the remaining digits identify an element or component in the drawing. Similar elements or components between different figures may be identified by the use of similar digits. For example, 110 may reference element “10” in FIG. 1, and a similar element may be referenced as 210 in FIG. 2.

FIG. 1 provides an illustration of a Customer Shopping List 100 according to the present disclosure. The embodiment of FIG. 1 includes customer information section 102 where information such as a customer's name, phone number, fax number, and/or electronic mail (email) address can be listed.

In addition, in some embodiments, the customer information section 102 can provide places to list a general contractors name, phone number, fax number, and/or email address. In some embodiments, the customer information section 102 can provide a place to list the sheet number of the customer shopping list 100. Other information can be provided in the customer information section 102, including a project identifier, such as a project name and/or number and/or a project description, among other things.

In some embodiments, the information provided in the customer information section 102 can be obtained by conducting a meeting between the customer and a contractor. In addition to obtaining customer and contractor information, the meeting can be used by the contractor to determine how far along the customer is in the planning process by having the customer fill out a questionnaire. The questionnaire can include several different questions for the customer including, but not limited to, whether the customer has obtained financing, whether the customer has obtained insurance, whether the customer has an architect, and/or when the customer would like to start the project. Other questions are also possible.

In various embodiments, the customer information section 102 can be associated with a visual identifier. Visual identifiers can be used to help the user know what kind of information is to be contained in a particular section, as will be described in more detail herein. As used herein, “user” can include the customer, as defined herein, and/or a contractor, sub-contractor, or general contractor, among other types of users. The visual identifier can be a number of things including, but not limited to, one or more colors, shapes, labels, patterns, and/or numbers, among others.

In some embodiments, the visual identifiers are used throughout a number of forms to help the user identify like items by identifying the same visual identifier for a type of item on each form. In various embodiments, the visual identifiers can be used to help guide the user through a sequence of steps, for example, by using the same visual identifier for user instructions, the user can look for the user instruction visual identifier on each form to learn how to proceed with filling out that form and/or to learn which form can be filled out next.

In some embodiments, the customer shopping list 100 can include a user instructions section 104. The user instructions section 104 can include a visual identifier as described herein with respect to customer information section 102.

In various embodiments, the visual identifier can be one or more colors, shapes, numbers, patterns, and/or labels, among other things. In some embodiments, the visual identifier associated with the user instructions section 104 can be a color, as discussed herein. In various embodiments, the color can be visually distinguishable to the user so that the user can identify that the user instructions section 104 has a different visual identifier than that chosen for the customer information section 102.

In some embodiments, the visual identifier for different sections can also be varied. For example, the visual identifier for the user instructions section 104 can be a yellow color, and the visual identifier for the customer information section 102 can be a diamond shape.

In various embodiments, the user instructions section 104 can list instructions for the user. For example, the user instructions section 104 can tell a user to circle a category from a list provided in the user instructions section 104.

In some embodiments, the user instructions section 104 can include tips on how to fill out a form and/or instructions on how to proceed to the next form. For example, the user instructions section 104 can provide the user with guidance as to when the user needs to buy a customer item or the user instructions section 104 can provide information as to the general purpose of the form. Other instructions are also possible, as discussed herein.

The customer shopping list 100 can include a customer item section 106. In some embodiments, the customer item section 106 can provide spaces where a user can list, for example, a product name, a room location, a color, a model number, a serial number, a product cost, a quantity, accessories needed, a place of purchase, an address, a contact person, an order time (in days), and/or a delivery time (in days), among other things.

In various embodiments, the customer shopping list 100 can include a sheet totals section 108. The sheet totals section 108 can include a visual identifier that is distinguishable from visual identifiers for other sections or items, as discussed herein.

In some embodiments, the sheet totals section 108 can provide a place where the user can list the product cost, the quantity, the accessories cost, and/or the accessories quantity, among other things. In some embodiments, the product cost, the quantity, the accessories cost, and/or the accessories quantity can be copied from the customer item section 106 to the sheet totals section 108. The product cost, the quantity, the accessories cost, and/or the accessories quantity can, in various embodiments, be automatically entered into the sheet totals section 108 when each is entered into the customer item section 106, as discussed herein.

In some embodiments, the sheet totals section 108 can include a total cost section 110. The total cost section 110 can be associated with a visual identifier, as discussed herein.

In various embodiments, the sheet totals section 108 can include user instructions 104, for example, directed to the user when the user is a customer, and/or user instructions 104 on how to move through additional forms, as discussed herein.

In some embodiments, a customer can be given multiple forms like that shown in FIG. 1 to enable the customer to record data about specific items the customer would like to purchase throughout the project. By filling out forms such as that shown in FIG. 1, the customer is able to relay his or her vision and expectations clearly to the building team, and/or the customer can get a clear picture of the costs associated with different items.

In addition, by filling out forms like that shown in FIG. 1, the customer is able to make decisions on the type, quality, and availability of the materials to be used in the project. Also, by having a customer fill out a form, such as FIG. 1, for every product that has potential of being used in the project, the customer and/or the contractor is creating a file of products which can be evaluated later.

As discussed herein, a customer can fill out multiple forms like that shown in FIG. 1. Subsequently, a contractor and/or customer can take the customer items 106 listed on the customer shopping lists 100, and divide the customer items 106 into a number of categories. As used herein, the number of categories are used to group customer items 106 that have common attributes.

This information can then be entered on a number of category lists. For example, FIG. 2 provides an illustration of an Electrical List 212 according to an embodiment of the present disclosure. The embodiment of FIG. 2 includes a customer information section 202, as discussed herein.

The embodiment of FIG. 2 also includes an electrical item section 214. In some embodiments, for instance, the electrical item section 214 can include a list of items that an electrician can install. For example, the electrical item section 214 can include a list of items such as smoke detectors, ceiling fans, air conditioners, light fixtures, color of plugs and switches, cover plates, doorbells, telephone, television requirements, media equipment, disposal, ranges, ovens, microwaves, dusk to dawn features, and/or motion detectors, among others.

In some embodiments, the electrical item section 214 can provide a place where customer items from forms like that shown in FIG. 1 can be listed. For example, where the electrical item section 214 list provides “Smoke Detectors (110v),” a line in the electrical item list 216 corresponding to “Smoke Detectors (110v)” can be filled in with the type of smoke detector the customer listed on a form like that shown in FIG. 1. The cost of that specific smoke detector, also listed on a form like that shown in FIG. 1 can be listed in a totals section 218. In some embodiments, this process can be repeated for all items pertaining to the Electrical List 112.

In some embodiments, the electrical item list 216 can be associated with a visual identifier that is the same as-the customer item section 106 in FIG. 1. In addition, the electrical item list 216 can include a totals section 218 that can have the same visual identifier as the total cost section 110 on the customer shopping lists 100 illustrated in FIG. 1.

In some embodiments, the electrical list 212 can include an electrical items total 220 that is the sum of the amounts listed in the totals section 218 on the electrical list 212. In various embodiments, the electrical items total 220 can have the same visual identifier as the totals section 218.

In some embodiments, the customer will not complete a customer shopping list like that shown in FIG. 1 for any items. In such situations, the electrical list 212 can include an allotment section 222 where a general contractor can provide an estimate of the cost of electrical items like those listed in the electrical item section 214.

In some embodiments, the electrical list 212 can include user instructions 204 to provide instructions on how to move from an electrical list 212 to the next step in the sequence of steps. The user instructions 204 can be associated with a visual identifier for easy identification, as discussed herein.

As discussed herein, a contractor or customer can take customer items listed on the customer shopping lists and divide the customer items 106 into several categories. FIG. 2 is an illustration of an electrical list 212. Other categories can include plumbing, carpentry, painting, heating ventilating/air conditioning (HV/AC), landscaping, furniture, appliances, carpeting/flooring, and household items, among others. For each of these categories, there can be provided an item section, an item list, a totals section, a category total, and an allotment section like that described with respect to FIG. 2.

In some embodiments, the customer or contractor can fill out multiple forms similar to FIG. 2, including those listed above and additional forms. In various embodiments, the customer or contractor can fill out only the forms which are applicable to the project.

Once the customer or contractor has filled out the suitable category forms for their project, the totals (e.g., electrical items total 220) can be transferred to a customer totals form.

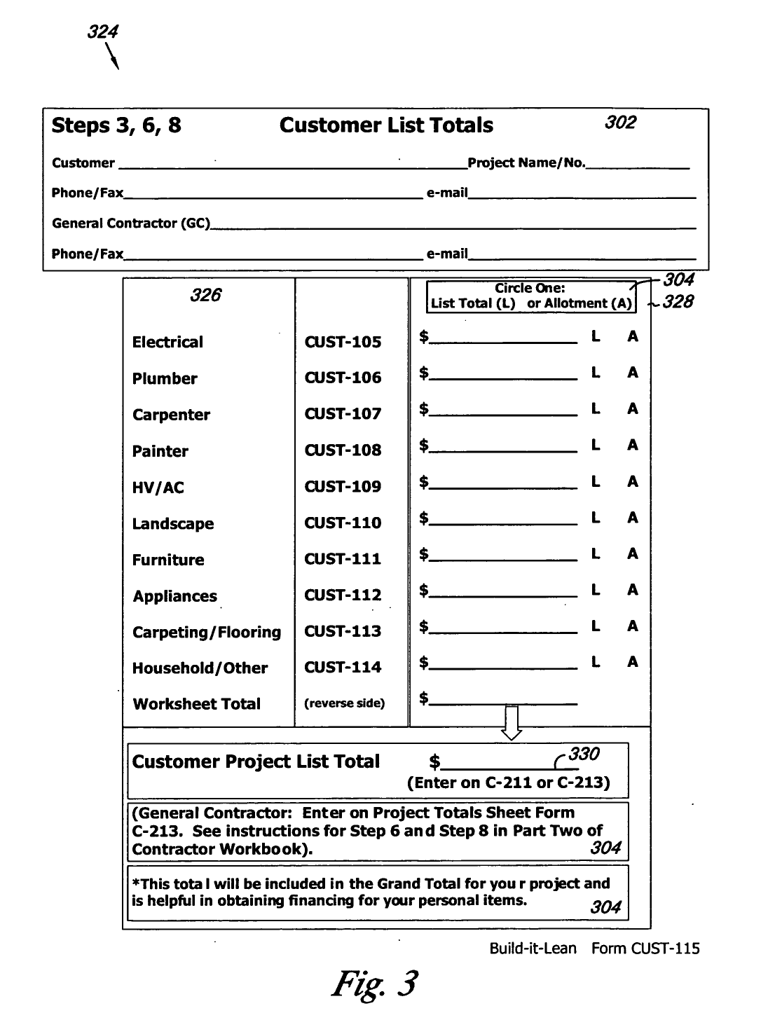

FIG. 3 provides an illustration of a customer totals form 324 according to an embodiment of the present disclosure. The embodiment of FIG. 3 includes a customer information section 302, as discussed herein. The embodiment of FIG. 3 also includes a category list 326, which provides a list of the categories that the customer items were separated into.

The embodiment of FIG. 3 also includes a category totals list 328 where the category total from the forms illustrated in FIG. 2 is transferred to correspond to the category in the category list 326. For example, the electrical items total can be entered to correspond to the “Electrical” category listed on FIG. 3.

In some embodiments, the customer totals form 324 can also include a customer total 330, which is the sum of the totals listed in the category totals list 328. In addition, in various embodiments, the category totals list 328 and the customer total 330 can be associated with the same visual identifier as the visual identifier for the electrical items total and the visual identifier for the total cost as discussed herein with respect to FIGS. 2 and 1, respectively.

The embodiment of FIG. 3 also includes user instructions 304, for example, directed toward the customer and/or the contractor to guide the customer and/or contractor to the next step in the sequence of steps. The user instructions 304 can be associated with a visual identifier, as discussed herein.

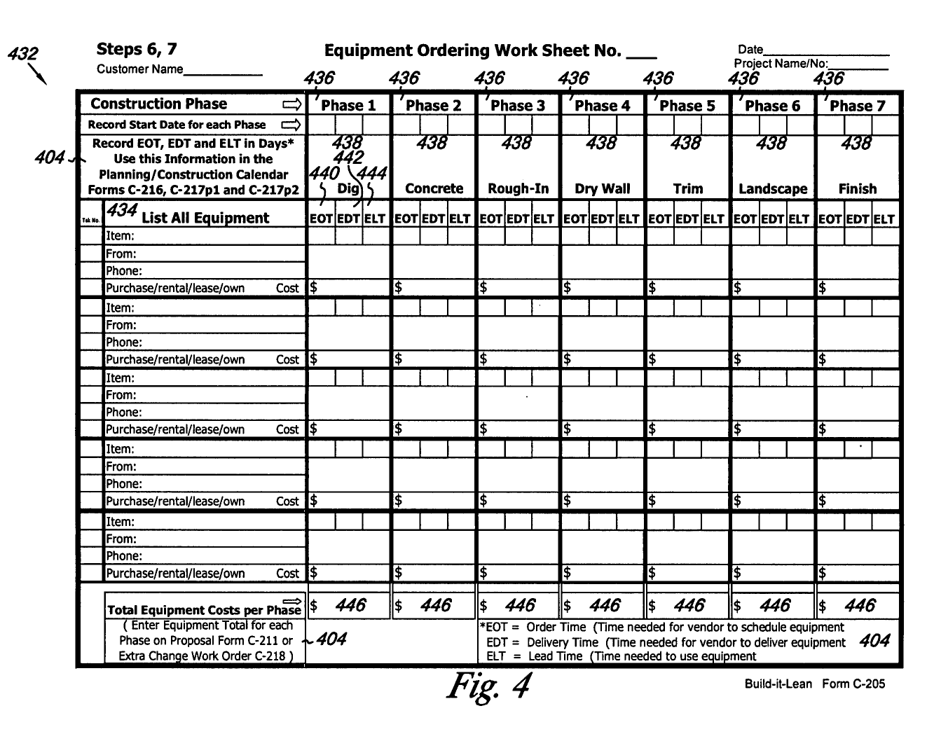

FIG. 4 provides an illustration of an Equipment Ordering Worksheet 432 according to an embodiment of the present disclosure. In some embodiments, the equipment ordering worksheet 432 can be used to record equipment to be used on a project and the equipment costs. The embodiment of FIG. 4, therefore, includes an equipment column 434 where the equipment item, the equipment location, and/or a phone number can be provided.

In addition, in some embodiments, the equipment ordering and costs can be broken up into a plurality of phases 436. As used herein, “plurality of phases” refers to stages in a project, such as a construction project.

In various embodiments, the plurality of phases 436 can be presumed to occur in a sequential order. For example, the plurality of phases 436 can include a dig phase, a concrete phase, a rough-in phase, a dry wall phase, a trim phase, a landscape phase, and a finish phase, among others. In addition, in some embodiments, each single phase in the plurality of phases 436 is to be completed before the next phase is started.

Also, in various embodiments, each phase in the plurality of phases 436 can be associated with a visual identifier. As discussed herein, the visual identifier can include one or more colors, shapes, numbers, patterns, and/or a combination of identifiers.

In addition, such visual identification schemes can be used throughout the embodiments of the present disclosure to help guide the user through the methods, systems, and apparatuses as described herein. In some embodiments, the one or more visual identifiers for the plurality of phases 436 can be a series of visually distinguishable identifiers that are different than other visual identifiers on the equipment ordering worksheet 432.

The embodiment of FIG. 4 also includes a place in each phase column 438 to list an equipment order time (EOT) 440, equipment delivery time (EDT) 442, and equipment lead time (ELT) 444. As used herein, “lead time” refers to the amount of time (e.g., in days), that it will take to complete the task.

For example, with respect to equipment, the ELT is the amount of time that the equipment will be used to complete the task that the equipment is to be used for. On the other hand, a lead time with respect to labor is the amount of time (e.g., in days) that it will take to finish the task completely, as discussed herein.

As discussed herein, the cost of each piece of equipment can be listed on the equipment ordering worksheet 432. In some embodiments, the equipment cost that is separated into the plurality of phases 436 can be added to obtain an equipment total per phase 446. The equipment total per phase 446 can be associated with the same visual identifier as the visual identifier for the category totals list and customer total with respect to FIG. 3, as discussed herein.

The embodiment of FIG. 4 also includes user instructions 404 directed toward the customer and/or the contractor to guide the customer and/or contractor to the next step in the sequence of steps. The user instructions 404, for example, can be associated with a visual identifier, as discussed herein.

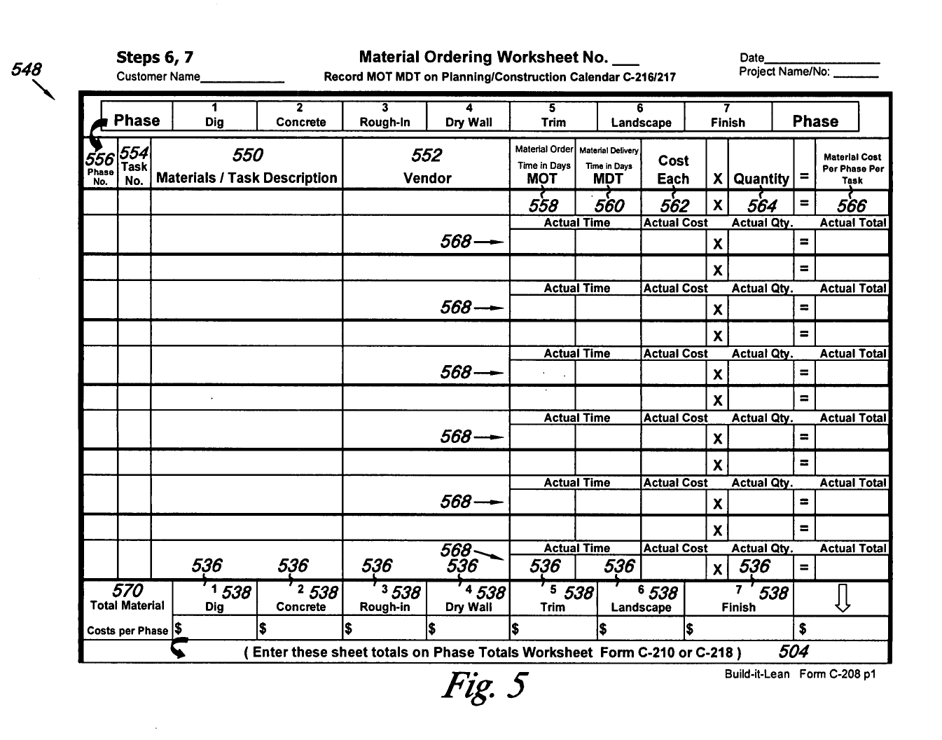

FIG. 5 provides an illustration of a Material Ordering Worksheet 548 according to an embodiment of the present disclosure. In some embodiments, the material ordering worksheet 548 can be used to list materials needed for the project along with order and delivery times and/or costs. The embodiment of FIG. 5 includes a materials column 550 where the materials and the task description can be provided.

In addition, the embodiment of FIG. 5 includes a vendor column 552 where the vendor for the material can be listed and a task column 554 where a task number can be listed. In some embodiments, the material ordering worksheet 548 can include a phase number column 556 where the phase during which the task is to be completed is listed.

The material ordering worksheet 548 of the embodiment of FIG. 5 also includes a material order time (MOT) column 558, a material delivery time (MDT) column 560, a cost each column 562, a quantity column 564, and a material cost per phase per task column 566. The MOT, MDT, cost, and quantity that are provided in the respective columns 558, 560, 562, 564, are, for example, estimates that a contractor will make based on the contractor's experience and on the customer shopping lists (e.g., FIG. 1) provided by the customer.

In addition, by reviewing the customer shopping lists, like that shown in FIG. 1, the contractor can be alerted to special material needs for installing the customer's products. Since the information provided in the MOT column 558, MDT column 560, the cost each column 562, and/or the quantity column 564 may be estimates, in some embodiments, the material ordering worksheet 548 can include a row 568 for each task description where a contractor can list the actual time it took to order and deliver a material, the actual cost, the actual quantity used, and/or the actual material cost per phase per task.

By filling out the row 568 of actual times, quantities, and/or costs and keeping the information, for example, in a file, the contractor can have accurate information to provide on a future bid when similar materials and tasks are required, saving both time and resources to submit the future bid. Other information can be provided on the material ordering worksheet 548.

The information listed on the material ordering worksheet 548 can be associated with a visual identifier, as discussed herein, including the materials column 550, the MOT column 558, the MDT column 560, the cost each column 562, the quantity column 564, and/or the material cost per phase per task column 566.

As discussed herein, the project can be separated into a plurality of phases 536. By listing the phase during which a task is to be completed in the phase number column 556, the costs per phase can be listed in a cost per phase row 570 associated with a phase column 538 for each of the plurality of phases 538.

As discussed herein, a visual identifier can be associated with each of the plurality of phases 538. In addition, the cost per phase row 570 can be associated with the same visual identifier as the equipment total per phase visual identifier with respect to FIG. 4, as discussed herein.

The embodiment of FIG. 5 also includes user instructions 504 directed toward the customer and/or the contractor to guide the customer and/or contractor to the next step in the sequence of steps. The user instructions 504 can be associated with a visual identifier, as discussed herein.

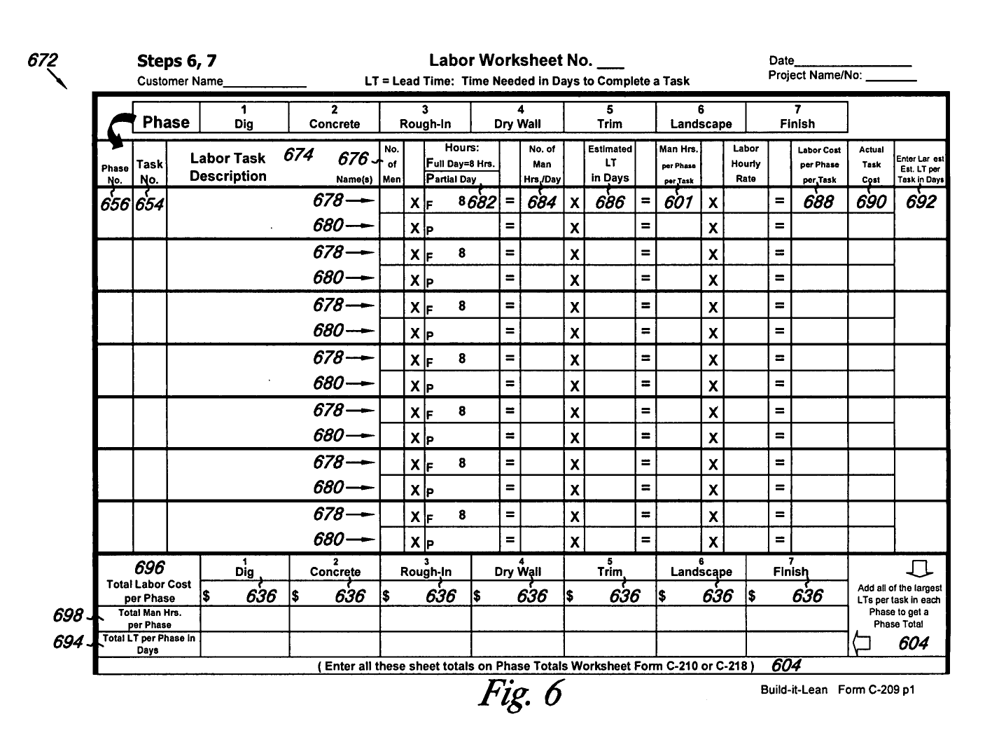

FIG. 6 provides an illustration of a labor worksheet 672 according to an embodiment of the present disclosure. In some embodiments, the labor worksheet 672 can be used to list labor needed for the project along with lead times and costs. The totals on the labor worksheet 672 can be used to determine how long it will take (e.g., in days) to complete a phase of the project, as discussed herein.

The embodiment of FIG. 6 includes a labor task description column 674 that provides a space for the contractor to describe each task. In addition, the embodiment of FIG. 6 includes a task column 654 where the task number can be listed and a phase number column 656 where the phase during which the task is to be completed is listed, as discussed herein.

The embodiment of FIG. 6 also includes a number of men column 676 where the number of employees available to complete a task can be listed. In addition, a number of rows can be provided for a task, such as a full time row 678 and a part time row 680, so that the number of employees can be separated into full time and part time employees or other classifications.

For the part time row 680, an hours column 682 can be provided so that the number of hours a part time employee works can be recorded in the part time row 680. By multiplying the number of employees from the number of men column 676 by the hours worked from the hours column 682, a number of man hours per day can be obtained for both the full time and part time employees and the number of man hours per day can be listed in a number of man hours per day column 684.

The embodiment of FIG. 6 also includes an estimated lead time column 686 where the contractor lists the estimated time to complete a task. In some embodiments, it is helpful to list all lead times as a lead time in days to maintain consistency. It can also help a contractor schedule tasks. In such embodiments, the methods, systems, and apparatuses of the present disclosure can provide a way to convert a lead time in hours into a lead time in days. For example, a contractor can estimate that a task can be completed in sixty (60) hours. To calculate what the lead time is in days, the systems, methods, and apparatuses can include an equation to enable the contractor to convert the lead time in hours to a lead time in days. An exemplary equation can be:

Number of Days=Number of hours/8 hours per day

Thus, for the example described above, the number of days would equal seven and one half (7.5) days, since sixty (60) divided by eight (8) equals seven and one half (7.5). In some embodiments, a chart listing hours in one column and days in an adjacent column can be provided. In such embodiments, a contractor can look for the specific number of hours, for example, sixty (60), and look to the adjacent column to find the corresponding amount of days, for example, seven and one half (7.5).

Providing lead times in days can help to maintain consistency, as discussed herein, it can also help a contractor schedule tasks. For example, if a lead time in days is equal to seven and one half (7.5) days, the contractor is alerted that unless the contractor schedules the start of the next task for the seventh day, a half day will be lost. By alerting the contractor to such occurrences, the contractor can finish a project closer to both a scheduled finish date and an estimated budget than had the contractor provided lead times using hours and/or provided lead times in both hours and days.

In addition, charts and/or equations can be provided to show lead times in days per employee, where the lead times in days are divided by the number of employees that a contractor can employ for a specific task. Other conversions charts and/or equations can also be provided.

In addition, the embodiment of FIG. 6 includes a labor cost per phase per task column 688. The labor cost per phase per task can be obtained by multiplying the number of man hours per day by the estimated lead time to obtain the man hours per phase per task, which can be listed in a man hours per phase per task column 601. The man hours per phase per task can then be multiplied by the labor hourly rate to obtain the labor cost per phase per task and recorded in the labor cost per phase per task column 688. In addition, in some embodiments, an actual task cost column 690 can be provided so that a contractor can list the actual cost that a task took to complete. The actual task cost can be helpful when the contractor is bidding on future projects where similar tasks are to be accomplished.

In some embodiments, an estimated lead time can be listed in the estimated lead time column 686, as discussed herein. Additionally, the largest estimated lead time can also be listed in a largest estimated lead time column-692.

The largest estimated lead time is the lead time that is the greatest among a number of tasks that are to be completed at the same time. For example, task 6 to be completed during a landscaping phase can include laying sod for a yard and planting bushes. While both laying the sod and planting bushes can be started at the same time, laying the sod may have a lead time of one day, while planting bushes may have a lead time of a half day. In this case, the largest estimated lead time to be entered into the largest estimated lead time column 692 would be one day.

Once the largest estimated lead time column 692 has been filled out for each task, all of the largest lead times per task in each of the plurality of phases 636 can be added together to calculate the lead time for each of the plurality of phases 636. The lead time for each of the plurality of phases 636 can then be entered into the total lead time per phase row 694.

In some embodiments, the labor cost per phase can be calculated by adding the totals for each phase from the labor cost per phase per task column 688 and entered into the total labor cost per phase row 696. Similarly, in some embodiments, the total man hours per phase can be calculated by adding the totals for each phase from the man hours per phase per task column 601 and entered into the total man hours per phase row 698.

As discussed herein, the plurality of phases 636 can be associated with visual identifiers, for example, to distinguish each phase. In addition, in some embodiments, the labor task description column 674 can be associated with a visual identifier that is the same as columns containing information having to do with labor including the total man hours per phase row 698. Also, in some embodiments, the total labor cost per phase row 696 can have the same visual identifier as the cost per phase row 570 visual identifier with respect to FIG. 5, as discussed herein.

The embodiment of FIG. 6 also includes user instructions 604 directed toward the customer and/or the contractor to guide the customer and/or contractor to the next step in the sequence of steps. The user instructions 604 can be associated with a visual identifier, as discussed herein.

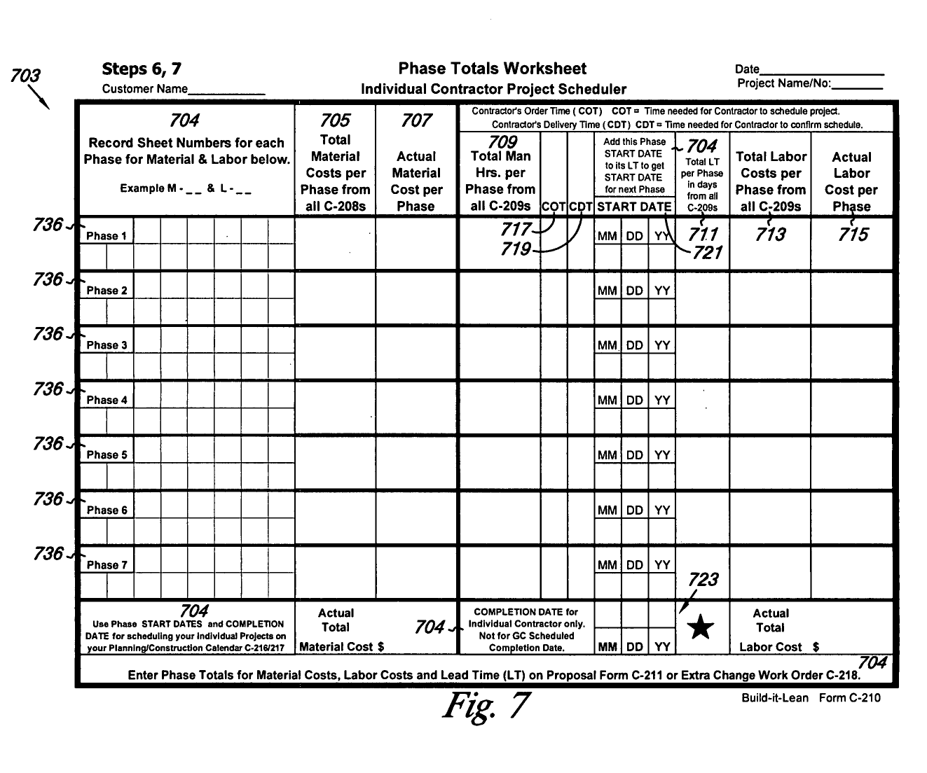

FIG. 7 provides an illustration of a phase totals worksheet 703 according to an embodiment of the-present disclosure. The totals obtained on the material ordering worksheet and the labor worksheet can then be added together and recorded respectively onto the phase totals worksheet 703. For example, the cost per phase row 570 on the material ordering worksheet 548 on FIG. 5 can be entered into the total material cost per phase column 705 on FIG. 7.

The embodiment of FIG. 7 also includes an actual material cost per phase column 707, a total man hours per phase column 709, a total lead time per phase column 711, a total labor cost per phase column 713, and an actual labor cost per phase column 715. Each of the columns can be filled in, for example, with information provided on the material ordering worksheet (e.g., FIG. 5) and the labor worksheet (e.g., FIG. 6).

The embodiment of FIG. 7 also includes a time needed for contractor to schedule project (COT) column 717 and a time needed for contractor to confirm schedule (CDT) column 719. Each of these columns is provided so that the contractor can estimate how long it will take to start scheduling and confirming the schedule for each phase of the project. This information is helpful so that a contractor can know how long before the start date of each phase he or she should start scheduling the equipment, materials, and/or labor for each phase.

The embodiment of FIG. 7 also includes a start date column 721 where a start date for each phase can be listed. For example, to obtain the start date for each phase, first the start date for the first phase can be listed. In such embodiments, to obtain the start date for the second phase, the total lead time listed in the total lead time per phase column 711 for the first phase is added to the start date for the first phase listed in the start date column 721.

A similar process can be used to obtain the start date for each phase. Specifically, for example, the lead time for the next phase can be added to the start date for the previous phase to calculate the start date for the next phase. This process can be repeated until a completion date 723 is obtained.

In some embodiments, as discussed herein, each of the plurality of phases 736 can be associated with the same visual identifier as the visual identifier used for each of the plurality of phases with respect to FIGS. 4, 5, and 6. In addition, in some embodiments, total material cost per phase column 705 can be associated with the same similar visual identifier as that used with respect to the materials column 500 in FIG. 5. Also, in some embodiments, the total lead time per phase column 711 and the total labor cost per phase column 713 can be associated with the same visual identifier as the visual identifiers used for the estimated lead time column 686 and the labor cost per phase per task column 688, respectively, in FIG. 6.

The embodiment of FIG. 7 also includes user instructions 704 directed toward the customer and/or the contractor to guide the customer and/or contractor to the next step in the sequence of steps. The user instructions 704 can be associated with a visual identifier, as discussed herein.

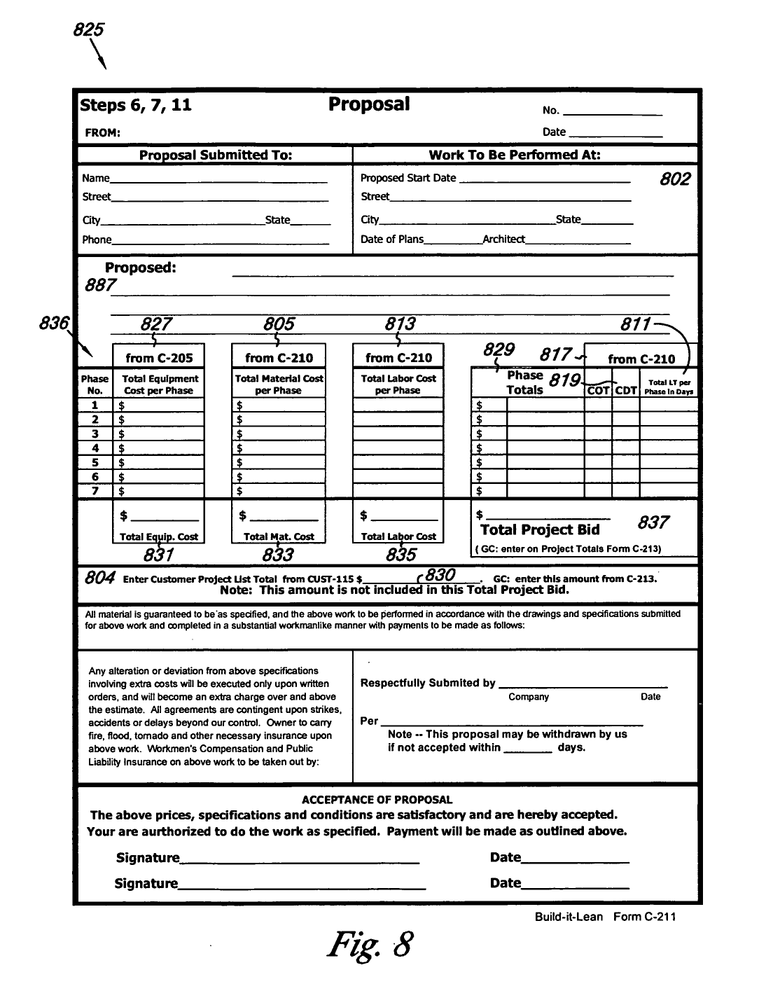

FIG. 8 provides an illustration of a proposal form 825 according to an embodiment of the present disclosure. The embodiment of FIG. 8 includes a customer information section 802 where the customer's name and/or address can be listed. In various embodiments, the address of the project and the proposed start date can be provided on the proposal form 825. In some embodiments, the customer information section 802 can be associated with the same visual identifier as the visual identifier in the customer information section 102 in FIG. 1.

The embodiment of FIG. 8 also includes a description section 887. The description section 887 provides a place for a contractor, sub-contractor, or other user to provide a summary of the work to be performed. For example, a landscape sub-contractor using proposal form 825 could provide a description of the landscaping, including, for example, laying sod, building a retaining wall, and/or planting shrubbery.

The embodiment of FIG. 8 also includes a total equipment cost per phase column 827, a total material cost per phase column 805, and a total labor cost per phase column 813. In some embodiments, the total equipment cost per phase column 827 a field for each of the plurality of phases 836, where the total equipment cost per phase can be entered.

In various embodiments, the total equipment cost per phase can be copied from the totals obtained in the equipment total per phase 446 from FIG. 4. In addition, the total equipment cost per phase column 827 can have the same visual identifier as the visual identifier in the equipment column 434 in FIG. 4.

In some embodiments, the total material cost per phase column 805 can have a field for each of the plurality of phases 836, where the total material cost per phase can be entered. In various embodiments, the total material cost per phase can be copied from the totals obtained in the total material cost per phase column 705 in FIG. 7. In addition, the total material cost per phase column 805 can have the same visual identifier as the total material cost per phase column 705 visual identifier in FIG. 7.

In some embodiments, the total labor cost per phase column 813 can have a field for each of the plurality of phases 836, where the total labor cost per phase can be entered. In some embodiments, the total labor cost per phase can be copied from the totals obtained in the total labor cost per phase 713 in FIG. 7. In addition, the total labor costs per phase column 813 can have the same visual identifier as the total labor cost per phase column 713 visual identifier in FIG. 7.

The embodiment of FIG. 8 also includes a phase totals column 829. To obtain the phase totals for each of the plurality of phases 836, the total equipment cost per phase, the total material cost per phase, and the total labor cost per phase provided in columns 827, 805, and 813, respectively, for example, can be summed.

In addition, the total equipment cost per phase column 827 can also include a total equipment cost 831. In some embodiments, the total equipment cost 831 can be obtained by summing the total equipment cost per phase for each of the plurality of phases 836.

Similarly, the total material cost per phase column 805 and the total labor cost per phase column 813 can include a total material cost 833 and a total labor cost 835, respectively. In some embodiments, the total material cost 833 and total labor cost 835 can be obtained by summing the total material cost per phase 805 and the total labor cost per phase 813 for each of the plurality of phases 836, respectively.

The embodiment of FIG. 8 also includes a time needed for contractor to schedule project column 817, a time needed for contractor to confirm schedule column 819, and a total lead time per phase column 811. The values entered into the columns can be, for example, copied from the phase totals worksheet 703 (e.g., FIG. 7). For instance, the time needed for contractor to schedule project column 717, the time needed for contractor to confirm schedule column 719, and/or the total lead time per phase column 711 can be provided.

The embodiment of FIG. 8 includes a total project bid 837 which, for example, can be calculated by the sum of the total equipment cost 831, the total material cost 833, and the total labor cost 835. In some embodiments, the total project bid 837, the total equipment cost 831, the total material cost 833, and/or the total labor cost 835 can have the same visual identifiers as the visual identifiers for the cost per phase row 570 with respect to FIG. 5, as discussed herein.

The embodiment of FIG. 8 also includes a place where the contractor can list a customer total 830. The customer total 830 can, for example, be copied from the customer total 330 on FIG. 3.

The embodiment of FIG. 8 also includes user instructions 804 directed toward the customer and/or the contractor to guide the customer and/or contractor to the next step in the sequence of steps. The user instructions 804 can be associated with a visual identifier, as discussed herein.

In some embodiments, a customer can hire a general contractor to accumulate bids from sub-contractors to obtain an overall project bid. A sub-contractor can, for example, be a contractor who performs only a portion of the work on a project. A general contractor can, for example, be a contractor who oversees the work on a project. In some embodiments, a general contractor can oversee the work on a project and also perform a portion of the work on the project. In such instances, the general contractor may provide information to the customer as both a general contractor and a sub-contractor.

In some embodiments, a general contractor can seek out bids from sub-contractors to enable the general contractor to submit an overall project bid to the customer. In such embodiments, each sub-contractor can fill out forms similar to those shown in FIGS. 4 through 8.

As such, the general contractor can receive from each sub-contractor a proposal form (e.g., FIG. 8) that contains a total equipment cost per phase, a total material cost per phase, a total labor cost per phase, and/or a total project bid, as discussed herein. In addition, in some embodiments, the general contractor can receive from each sub-contractor a phase totals worksheet (e.g., FIG. 7) that provides the start dates for each of the plurality of phases based on the lead times for each phase that each sub-contractor estimates for his or her portion of the work.

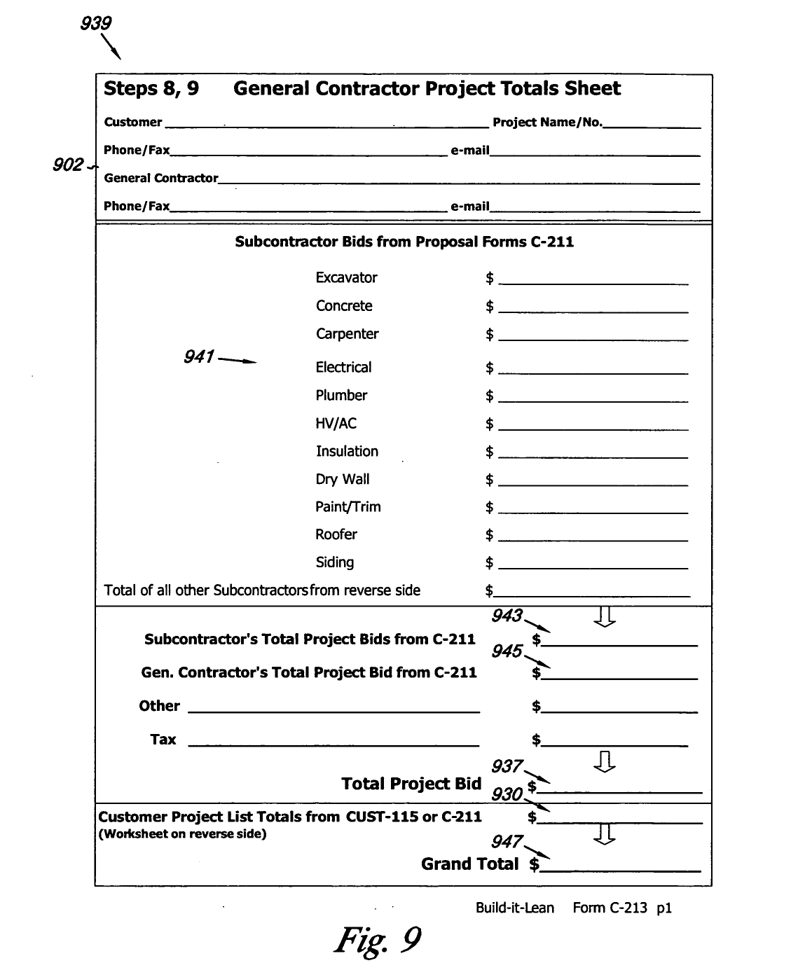

FIG. 9 provides an illustration of a general contractor project totals sheet 939 according to an embodiment of the present disclosure. The embodiment shown in FIG. 9 includes a customer information section 902 which can be associated with a visual identifier similar to other customer information sections in FIGS. 1-9, as discussed herein.

The embodiment shown in FIG. 9 also includes a subcontractor bid list 941 where a list of sub-contractors is listed, and a line is provided for each where a general contractor can fill in the sub-contractor bids received. The general contractor can obtain each sub-contractor bid by copying the total project bid 837 from the proposal form (e.g., FIG. 8) submitted by each sub-contractor to the line provided for each sub-contractor in the sub-contractor bid list 941. The general contractor can then sum the sub-contractor bids in the sub-contractor bid list 941 to calculate a sub-contractor's total project bids 943.

As discussed herein, in some embodiments, the general contractor can perform a portion of the work on a project, similar to a sub-contractor. In such embodiments, the general contractor can fill out a proposal form (e.g., FIG. 8) to provide a bid price for that portion of the work. The embodiment of FIG. 9 includes a general contractor's total project bid 945 so the general contractor can submit the general contractor's bid for the portion of the work that the general contractor will perform. In some embodiments, the general contractor can fill in the general contractor's total project bid 945 by copying the amount of the total project bid 837 from the general contractor's proposal 825 (e.g., FIG. 8).

The embodiment of FIG. 9 also includes a total project bid 937 that is calculated by summing the sub-contractor's total project bids 943, the general contractor's total project bid 945, and any other miscellaneous fees. In addition, the embodiment of FIG. 9 includes a grand total 947 which can be calculated by summing the total project bid 937 with the customer total 930. In some embodiments, the customer total 930 can be copied from the customer total in the customer totals form (e.g., FIG. 3).

In some embodiments, once the general contractor has filled out a general contractor project totals sheet 939, the general contractor can present this form to the customer. In some embodiments, if the customer would like any alterations to any of the bids, the customer can tell the general contractor at this time. If the customer is satisfied with the sub-contractor bids 941 and the grand total 947, the general contractor can fill out a proposal form (e.g., FIG. 8) for the entire project.

In some embodiments, when the general contractor fills out a proposal form 825 for the entire project, the total equipment cost per phase column 827 can be filled in with the total equipment cost per phase from each of the sub-contractors. Similarly, the general contractor can enter the total material cost per phase and the total labor cost per phase into their respective columns 805, 813 by summing the total material cost per phase from each of the sub-contractors and the total labor cost per phase from each of the sub-contractors. In some embodiments, the entire project phase totals can be obtained and found in the phase totals column 829 by adding the phase totals for each of the total equipment cost per phase, the total material cost per phase, and/or the total labor cost per phase.

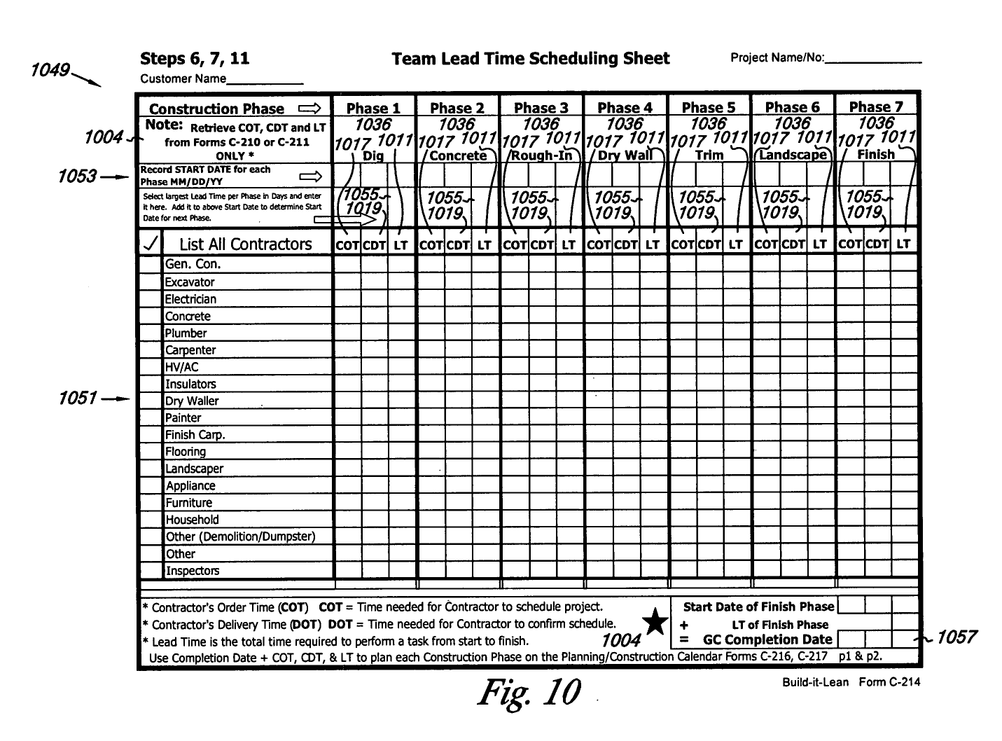

FIG. 10 provides an illustration of a team lead time scheduling sheet 1049 according to an embodiment of the present disclosure. The embodiment of FIG. 10 includes columns for a plurality of phases 1036 where a general contractor can list the time needed to schedule a project 1017, the time needed to confirm the schedule 1019, and the total lead time per phase 1011 for each of the plurality of phases 1036.

In some embodiments, the general contractor can do this for each of the sub-contractors in the sub-contractor list 1051. In some embodiments, the general contractor can obtain the information to fill out the team lead scheduling sheet 1049 by copying the values entered into the time needed to schedule a project column, the time needed to confirm the schedule, and the total lead time per phase column from the phase totals worksheet (e.g., FIG. 7) or the proposal form (e.g., FIG. 8) submitted by each sub-contractor.

The embodiment of FIG. 10 includes a start date row 1053. In some embodiments, the general contractor can enter a start date for the first phase in the plurality of phases 1036 in the start date row 1053. The general contractor can then select the largest lead time per phase from the total lead time per phase column 1011, and enter it into the lead time box 1055. To obtain the start date for the next phase in the plurality of phases 1036, the start date for the first phase is added to the lead time in the lead time box 1055. For example, if the start date for phase 1 is Jul. 7th, 2006 and the lead time listed in the lead time box 1055 is 10 days, the start date for phase 2 is Jul. 21st, 2006 using a five-day work week. In some embodiments, this method is repeated until a completion date 1057 is obtained by adding the lead time of the last phase in the plurality of phases 1036 to the start date for the last phase in the plurality of phases 1036.

The embodiment of FIG. 10 also includes user instructions 1004 directed toward the customer and/or the contractor to guide the customer and/or contractor to the next step in the sequence of steps. The user instructions 1004 can be associated with a visual identifier, as discussed herein. In some embodiments, the plurality of phases 1036 can be associated with the same visual identifier as the visual identifiers used for the plurality of phases on the phase totals worksheet (e.g., FIG. 7) and on the proposal (e.g., FIG. 8).

Once the start dates for each of the plurality of phases 1036 are entered into the start date row 1053, in some embodiments, the general contractor can enter these dates into a project calendar. In some embodiments, the general contractor can also transfer the information relating to the time needed to schedule a project and the time needed to confirm the schedule for each phase for each sub-contractor so that the general contractor can remind a sub-contractor when he or she should start planning for the next phase.

In some situations, after a project has been bid, accepted by the customer, scheduled, and/or work has begun on the project, extra work can be requested or needed that was unexpected or unknowable at the time of bidding. In such situations, the general contractor can submit a change work order form to the customer so that the general contractor has a record of the extra work provided and can ultimately be reimbursed for the extra work.

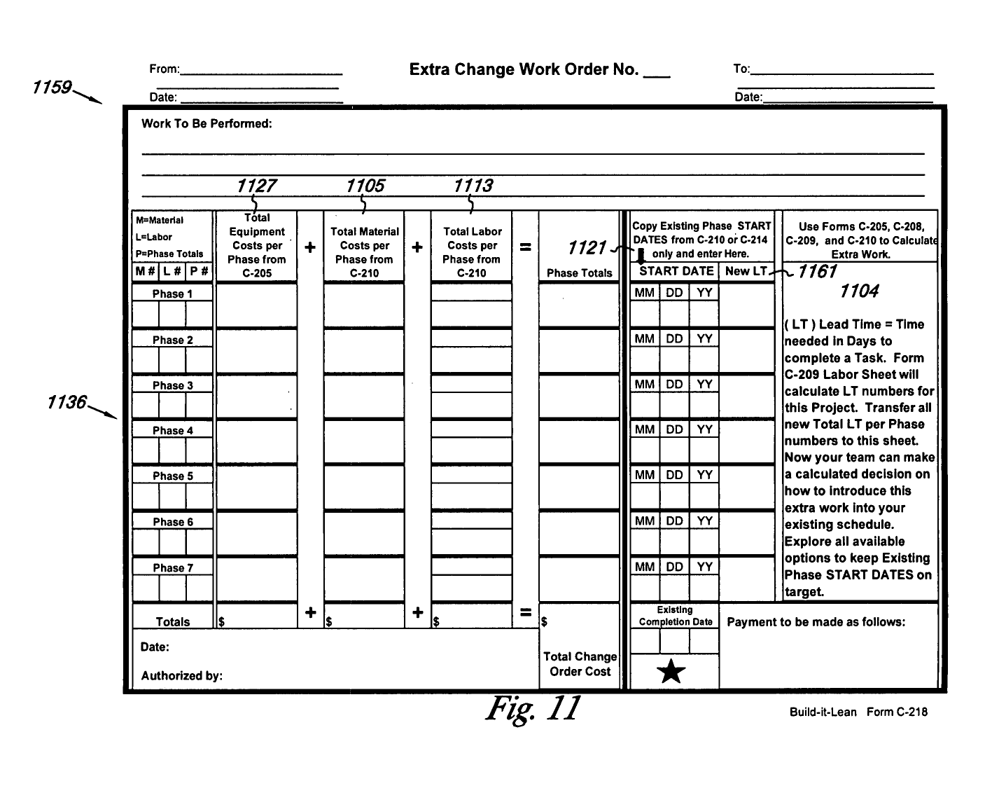

FIG. 11 provides an illustration of an extra change work order form 1159 according to an embodiment of the present disclosure. The embodiment of FIG. 11 includes a total equipment cost per phase column 1127, a total material cost per phase column 1105, and a total labor cost per phase column 1113 so that the total equipment cost, material cost, and labor cost can be separated into the plurality of phases 1136.

In addition, the embodiment of FIG. 11 includes a start date column 1121 and a new lead time column 1161. Each column can be associated with the same visual identifier as the visual identifier used for the equipment, materials, and/or labor, respectively, in FIGS. 5, 6, 7, and 8, as discussed herein.

In some embodiments, to obtain the information to fill out the extra change work order form 1159, an equipment ordering worksheet (e.g., FIG. 4), a material ordering worksheet (e.g., FIG. 5), a labor worksheet (e.g., FIG. 6), and/or a phase totals worksheet (e.g., FIG. 7) can be filled out for the extra work. The forms can be filled out as discussed herein, for the equipment, materials, and/or labor to be used to perform the extra work.

The embodiment of FIG. 11 also includes user instructions 1104 directed toward the customer and/or the contractor to guide the customer and/or contractor to the next step in the sequence of steps. The user instructions 1104 can be associated with a visual identifier, as discussed herein.

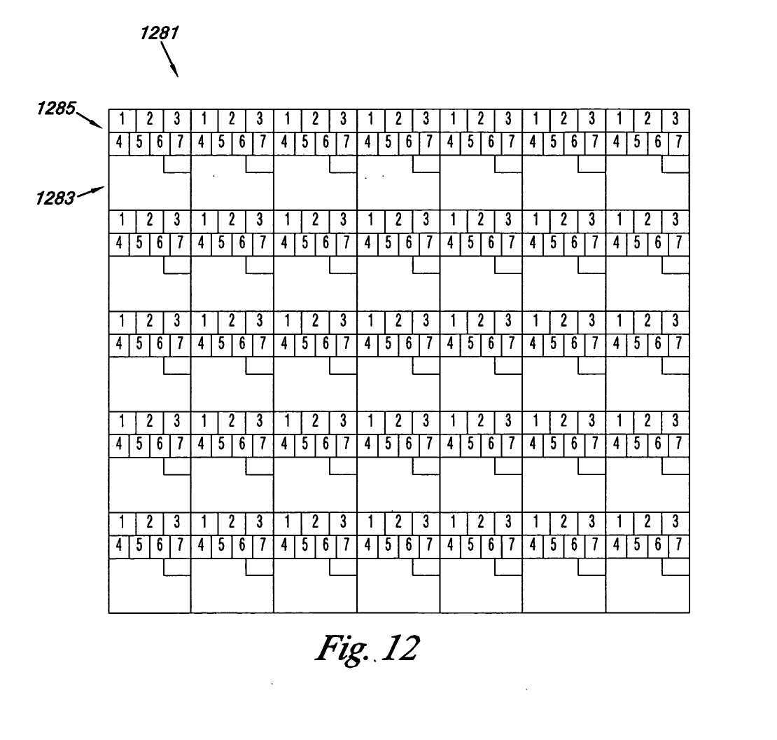

FIG. 12 provides an illustration of a calendar 1281 according to an embodiment of the present disclosure. As discussed herein, a general contractor can copy the start dates for each of the plurality of phases for a project to a calendar 1281 to help the general contractor keep track of important dates. Other information that can be copied to the calendar 1281 can include the tasks that are to be completed in each phase, the equipment order and delivery times, the material order and delivery times, and/or the number of men that are to perform each task. In various embodiments, the general contractor can copy this information to a calendar 1281 where a calendar date box 1283 can have a row 1285 listing the plurality of phases. The plurality of phases can be associated with a visual identifier, as discussed herein.

In some embodiments, the calendar 1281 can be transparent. In such embodiments, the general contractor can overlay the calendar 1281 for one project with the calendar 1281 for another project, or a plurality of calendars 1281 from various projects, and the general contractor can see open dates when extra work can be performed.

In some embodiments, the methods and systems of the present disclosure can be provided by a computing device and/or system on a computer readable medium. Embodiments of the present disclosure described herein can be performed by software and/or firmware (i.e., computer executable instructions), hardware, application modules, and the like, executable and/or resident on systems, ASICs, and devices shown herein or otherwise.

The embodiments of the present disclosure are not limited to any particular operating environment or to instructions written in any particular programming language. Software, firmware, and/or processing modules suitable for carrying out embodiments of the present disclosure can be resident in one or more devices or locations. Processing modules can include separate modules connected together or several modules on an application specific integrated circuit (ASIC).

By putting forms similar to the embodiments shown in FIGS. 1-12 onto a computer readable medium, a user can use an electronic version of the forms of the various embodiments. In some electronic embodiments, a user can print out a form to fill out, for example, on the job site or give it to a sub-contractor and/or customer to fill out, and the sub-contractor and/or customer can return it to the user once the form has been filled out. At this time, in some embodiments, the user can enter the values provided by the customer and/or sub-contractor into an electronic version of the form, and the computer readable medium can include executable instructions to fill in values on different forms automatically based on what the user enters.

For example, an electrician sub-contractor can give a proposal (e.g., FIG. 8) to a general contractor for a specific project. Once the general contract enters values into the time needed to schedule project column 817, time needed to confirm schedule column 819, and the lead time column 811 for each of the plurality of phases 1036, the computer readable medium can include executable instructions that direct the program to transfer the values entered into the proposal into the team lead time scheduling sheet (e.g., FIG. 10) in the Electrician row.

In some embodiments, the systems, methods, and apparatuses embodiments described herein can be provided on a computing device, system, and/or a computer readable medium that can be accessible via the Internet. In some embodiments, the sub-contractors and/or customers can fill out forms similar to the embodiments described with respect to FIGS. 1-12 electronically, and submit the forms to the general contractor via the Internet.

In such embodiments, the general contractor can receive and accept the completed forms electronically. In some embodiments, when the general contractor accepts the electronic forms, the values entered by the customer and/or sub-contractor can be automatically entered into other forms, such as the team lead time scheduling sheet and/or a calendar, among other forms, as discussed herein.

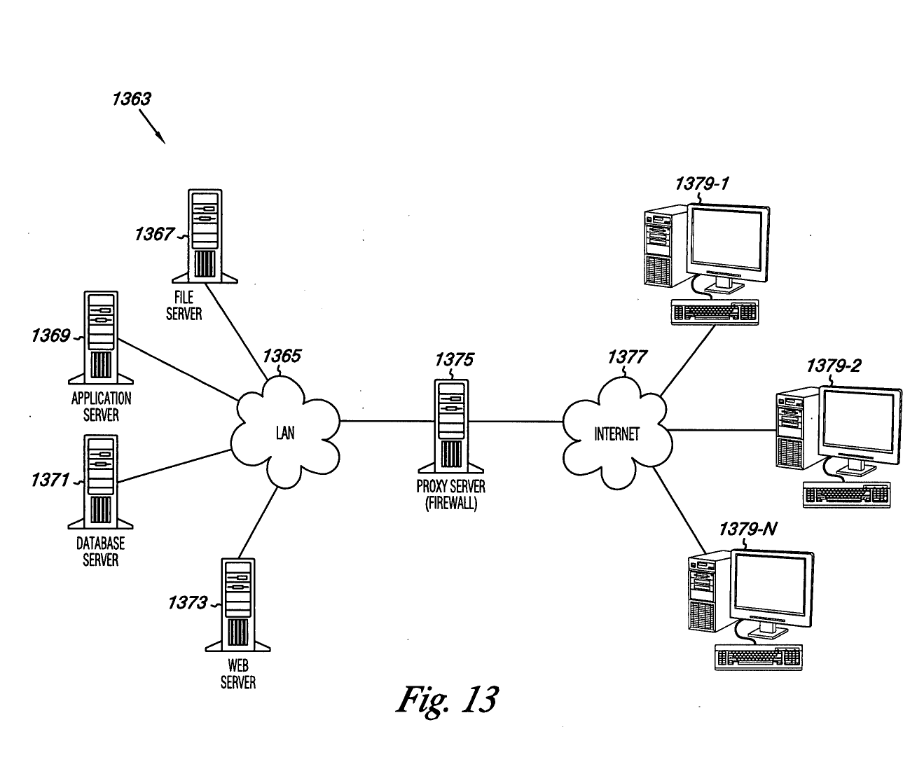

FIG. 13 is an illustration of an embodiment according to the present disclosure where the embodiments are provided on a computing system and are accessible using the Internet. FIG. 13 illustrates an exemplary computing network 1363 suitable for implementing embodiments of the present disclosure.

A number of network devices (e.g. personal computers, servers, computing peripherals, etc.) can be networked together via a local area network (LAN) 1365. Devices can also be networked together via other kinds of networks. The embodiment of FIG. 13 illustrates a number of servers networked together through the LAN 1365.

The servers connected together through the LAN 1365 include a file server 1367, an application server 1369, a database server 1371, a web server 1373, and a proxy server 1375. A LAN can also include various other servers and other devices.

The file server 1367 can store various files and executable instructions on file server 1367 can execute to provide access to those files through the LAN 1365. The application server 1369 can store various program applications with various executable instructions, which can be executed over the LAN 1365.

The database server 1371 can store various databases and executable instructions on server 1371 can execute to provide access to those databases through the LAN 1365. For example, the database server 1371 can store a database with past project estimates including proposals, equipment ordering worksheets, material ordering worksheets, and/or labor worksheets, among others as described herein.

In addition, executable instructions on web server 1373 can execute to provide various services associated with the Internet's World Wide Web. For example, executable instructions on web server 1373 can execute to provide access to one or more web pages on an Internet website which can provide material costs, order times, and/or delivery times that can be used to determine and/or compare material suppliers.

The information on the website can be displayed in various information and input fields and, in some embodiments, adjusted to allow a sub-contractor or general contractor to choose which materials supplier is best fitted to the project. The proxy server 1375 can connect the LAN 1365 to the Internet 1377 and can serve as a firewall between them.

A number of computing devices can also connect to the Internet 1377. FIG. 13 shows computing devices 1379-1, 1379-2, . . . , 1379-N. The designator “N” is intended to represent that a number of computing devices can be connected to the Internet 1377. The computing devices 1379-1, 1379-2, . . . , 1379-N are each connected to the Internet 1377.

These computing devices can connect to the Internet 1377 in various ways, such as through dial-up connections, cable lines, DSL lines, through other networks, etc.

These computing devices can access various information, such as information on one or more web pages, via the Internet 1377. The computing devices can be located in various locations (e.g., homes, businesses, financial aid offices, etc.). As described herein, customers, users, and/or contractors can use computing devices to bid and schedule a project through a website (e.g., via one or more web pages).

In some embodiments, the systems, methods, and apparatuses as described herein can be used as an education tool. In some embodiments, a bidding and/or scheduling process for a project can be taught by teaching a student how to use the various methods discussed herein. In some embodiments, the teaching can be aided by using visual identifiers to guide the student through a series of steps. In addition, in some embodiments, the visual identifiers can be used to teach how to organize collected information about a project.

For example, by associating visual identifiers to each of the plurality of phases, the student can follow all material, equipment, and/or tasks that are necessary to accomplish each of the plurality of phases. Similarly, by associating visual identifiers to equipment, materials, and tasks, the student learns where to enter information relating to each as the student steps through a series of forms, for example, forms similar to FIGS. 1-12.

Although specific embodiments have been illustrated and described herein, those of ordinary skill in the art will appreciate that an arrangement calculated to achieve the same techniques can be substituted for the specific embodiments shown. As one of ordinary skill in the art will appreciate upon reading this disclosure, various embodiments of the invention can be performed in one or more devices, device types, and system environments including networked environments.

Combination of the above embodiments, and other embodiments not specifically described herein will be apparent to those of skill in the art upon reviewing the above description. The scope of the various embodiments of the disclosure includes other applications in which the above structures and methods can be used. Therefore, the scope of various embodiments of the disclosure should be determined with reference to the appended claims, along with the full range of equivalents to which such claims are entitled.

In the foregoing Detailed Description, various features may have been grouped together in a single embodiment for the purpose of streamlining the disclosure. This method of disclosure is not to be interpreted as reflecting an intention that the embodiments of the invention require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A project scheduling method, comprising:
separating the project into a plurality of phases to be completed in a sequential order;
determining a first start date for a first phase and determining a next start date for a next phase in the plurality of phases by adding a first phase maximum lead time to the first start date;
determining a start date for each of the plurality of phases by adding a maximum lead time for each phase to a previous phase start date until a completion date is obtained;
determining when an action is to be taken regarding an item from one of an equipment list and a materials list based on the start date for each of the plurality of phases.

2. The project scheduling method -of claim 1, further including preparing the equipment list including at least one of a number of equipment staging times, equipment lead times, and equipment costs separated into the plurality of phases.

3. The project scheduling method of claim 2, wherein the equipment staging times include at least one of a number of equipment order times and equipment delivery times.

4. The project scheduling method of claim 2, further including preparing the materials list including at least one of a number of materials staging times and materials costs separated into the plurality of phases.

5. The project scheduling method of claim 4, wherein the materials staging times include at least one of a number of materials order times and materials delivery times.

6. The project scheduling method of claim 4, further including preparing the tasks list including at least one of a number of task descriptions, lead times, and labor costs separated into the plurality of phases.

7. The project scheduling method of claim 6, including calculating a total equipment cost per phase by summing the equipment costs for each of the plurality of phases, a total material cost per phase by summing the materials costs for each of the plurality of phases, and a total labor cost per phase by summing the labor costs for each of the plurality of phases.

8. The project scheduling method of claim 7, including calculating a total equipment cost by summing the total equipment cost per phase for each of the plurality of phases, a total materials cost by summing the total materials cost per phase for each of the plurality of phases, and a total labor cost by summing the total labor cost per phase for each of the plurality of phases.

9. The project scheduling method of claim 8, including calculating a total project bid by summing the total equipment cost, the total materials cost, and the total labor cost.

10. The project scheduling method of claim 1, including determining a time required to schedule and confirm the schedule for each of the plurality of phases and determining when an action is to be taken regarding scheduling based on the start dates for each of the plurality of phases.

11. The project scheduling method of claim 1, including attaching visual identifiers to each of the plurality of phases.

12. The project scheduling method of claim 11, wherein attaching visual identifiers to each of the plurality of phases includes assigning a color to each of the plurality of phases.

13. The project scheduling method of claim 12, wherein attaching visual identifiers to each of the plurality of phases includes assigning a number and a color to each of the plurality of phases.

14. The project scheduling method of claim 11, wherein attaching visual identifiers to each of the plurality of phases includes assigning a number to each of the plurality of phases.

15. A project planning, bidding, and scheduling system, comprising;
a plurality of customer shopping lists to indicate a number of customer items and an associated item cost for each of the number of customer items;
a plurality of categorical lists that include the number of customer items and associated item costs separated into a number of categories;
a customer totals list that includes a total cost for each of the plurality of categorically lists and a customer total for all of the number of categories;
an equipment ordering worksheet, a materials ordering worksheet, and a labor worksheet where equipment, materials, and tasks are separated into a plurality of phases;
a proposal to indicate an equipment total, a materials total, and a labor total for each of the plurality of phases and a total project bid;
a schedule to indicate the materials total, the labor total, and a start date, and a lead time for each of the plurality of phases; and
a calendar to indicate an equipment staging date, a materials staging date, and the start date for each of the plurality of phases.

16. The system of claim 15, where the equipment staging date includes an equipment order date and an equipment delivery date.

17. The system of claim 15, where the materials staging date includes a materials order date and a materials delivery date.

18. The system of claim 15, where the proposal also indicates the lead time for each of the plurality of phases from the schedule.

19. The system of claim 15, where the system further includes a change work order to indicate a work description, a second equipment total, a second materials total, a second labor total, and a second lead time for each of the plurality of phases.

20. The system of claim 15, where the calendar includes the tasks from the labor worksheet for the plurality of phases.

21. The system of claim 15, where the calendar is transparent and is overlaid on a second project calendar.

22. The system of claim 15, where the calendar is transparent and is overlaid on at least a second transparent project calendar.

23. The system of claim 15, where the calendar includes phase visual identifiers for the plurality of phases in a date box.

24. A method of bidding and scheduling a project using visual identifiers to link alike items and to guide a user through a sequence of steps, comprising:
separating the project into a plurality of phases to be completed and attaching phase visual identifiers to the plurality of phases;
attaching a plurality of visual identifiers to user instructions, equipment, materials, and labor throughout the sequence of steps; and
preparing a project bid and schedule by identifying a visual identifier attached to the user instructions and following the user instructions through the sequence of steps until a last step in the sequence of steps.

25. The method of claim 24, where preparing a project bid and schedule includes preparing an equipment ordering worksheet, a materials ordering worksheet, and a labor worksheet by identifying an equipment visual identifier, a materials visual identifier, and a labor visual identifier and by following the user instructions through the sequence of steps until the last step in the sequence of steps.

26. The method of claim 25, where preparing the equipment ordering worksheet includes listing an equipment staging time and an equipment cost on the equipment ordering worksheet, preparing the materials ordering worksheet includes listing a materials staging time and a materials cost on the materials ordering worksheet, and preparing the labor worksheet includes listing a labor cost and a lead time on the labor worksheet.

27. The method of claim 24, further including attaching a total visual identifier to a plurality of totals and calculating the project bid by summing the plurality of totals.

28. The method of claim 24, further including grouping the equipment, the materials, and the labor for the plurality of phases according to the phase visual identifiers for each of the plurality of phases.

29. The method of claim 24, further including attaching a calendar visual identifier to start dates for each of the plurality of phases and determining a start date for the plurality of phases by adding a maximum lead time for each phase to a previous start date until a completion date is obtained.

30. The method of claim 29, further including transferring the start date for each of the plurality of phases to a calendar.

31. The method of claim 30, further including providing the calendar with date boxes containing the phase visual identifiers for the plurality of phases, and where transferring the start date for each of the plurality of phases to the calendar includes marking a phase visual identifier to identify which of the plurality of phases the start date corresponds to.

32. A computer readable medium having executable instructions storable thereon to cause a device to perform a method, comprising:
inputting equipment for a project into an equipment list, materials for the project into a materials list, and tasks for the project into a labor list;
separating the equipment, materials, and tasks into a plurality of phases;
calculating a total equipment cost by summing equipment costs, a total materials cost by summing materials costs, and a total labor cost by summing labor costs and separating the total equipment cost, the total materials cost, and the total labor cost into the plurality of phases;
calculating a project bid by summing the total equipment cost, the total materials cost, and the total labor cost;
inputting a first start date for a first phase and determining a next start date for a next phase in the plurality of phases by adding a first phase maximum lead time to the first start date;
determining a start date for the plurality of phases by adding a maximum lead time for each phase to a previous phase start date until a completion date is obtained; and
transferring the start date for the plurality of phases to a calendar.

33. The computer readable medium of claim 32, including inputting equipment staging time into the equipment list and materials staging time into the materials list.

34. The computer readable medium of claim 33, including determining when an action is to be taken regarding an item from the equipment list based on the start date for the plurality of phases and the equipment staging time and determining when an action is to be taken regarding an item from the materials list based on the start date for the plurality of phases and the materials staging time.

35. The computer readable medium of claim 32, further including inputting a work description into a change work order and calculating a change work order cost by summing a second total equipment cost, a second total materials cost, and a second total labor cost.

36. The computer readable medium of claim 35, further including merging the calendar with a second calendar from a second project and determining open dates to perform an extra task associated with the change work order.

37. The computer readable medium of claim 35, further including merging the calendar with a plurality of calendars from a plurality of projects and determining open dates to perform an extra task associated with the change work order.

38. An educational tool, comprising:
a project bidding and scheduling system using visual identifiers to link alike items and to guide a user through a sequence of steps, including:
a plurality of phases to be completed and each phase identified by a phase visual identifier;
a plurality of visual identifiers attached to user instructions, equipment, materials, and labor throughout the sequence of steps;
an equipment ordering worksheet, a materials ordering worksheet, and a labor worksheet identified by the plurality of visual identifiers, where the equipment ordering worksheet, the materials ordering worksheet, and the labor worksheet include user instructions;
a total project bid identified by a totals visual identifier;
a schedule to indicate a start date for each of the plurality of phases identified by a calendar visual identifier; and
a calendar to indicate the start date for each of the plurality of phases indicated by the calendar visual identifier.

39. The educational tool of claim 38, where the total project bid is included in a proposal that indicates an equipment total, a materials total, and a labor total for each of the plurality of phases identified by the totals visual identifier.

40. The educational tool of claim 38, where the schedule further indicates a lead time for each of the plurality of phases identified by a lead time visual identifier.

41. The-educational tool of claim 38, where the calendar includes the phase visual identifiers for each of the plurality of phases in a calendar date box.
